(19) United States
(12) Patent Application Publication
(10) Pub. No.: US 2017/0180596 A1
(43) Pub. Date: Jun. 22, 2017

(54) APPARATUS, SYSTEM, AND METHOD OF CONTROLLING IMAGE FORMING APPARATUS WITH AUTONOMOUS NAVIGATION SYSTEM, AND RECORDING MEDIUM

(71) Applicant: Hitoshi SASAKI, Kanagawa (JP)

(72) Inventor: Hitoshi SASAKI, Kanagawa (JP)

(73) Assignee: Ricoh Company, Ltd., Tokyo (JP)

(21) Appl. No.: 15/378,148

(22) Filed: Dec. 14, 2016

(30) Foreign Application Priority Data
Dec. 18, 2015 (JP) 2015-247416

(51) Int. Cl. H04N 1/32; G05D 1/00; G05D 1/02; G06K 15/00; H04N 1/00

(52) U.S. Cl. CPC H04N 1/32523; G06K 15/40; H04N 1/00204; H04N 1/00344; H04N 1/32539; H04N 1/32101; G05D 1/021; G05D 1/0027; G06K 2215/0017; H04N 2201/0082; H04N 2201/0096; H04N 2201/0039; H04N 2201/3205; H04N 2201/3253; H04N 2201/3215; G05D 2201/0211

(57) ABSTRACT

A server for controlling a plurality of image forming apparatuses each provided with an autonomous navigation system that enables the image forming apparatus to travel to a destination: receives first location information indicating a current location of each image forming apparatus, and second location information indicating a current location of the information terminal; receives at least a monochrome printing time that indicates a time period in which the image forming apparatus performs monochrome printing when the image forming apparatus is not capable of performing color printing; and selects one of the plurality of image forming apparatuses as an image forming apparatus to perform printing according to the user request, based on the first location information, the second location information, and the device information.

### CROSS-REFERENCE TO RELATED APPLICATIONS

This patent application is based on and claims priority pursuant to 35 U.S.C. §119(a) to Japanese Patent Application No. 2015-247416, filed on Dec. 18, 2015, in the Japan Patent Office, the entire disclosure of which is hereby incorporated by reference herein.

### BACKGROUND

Technical Field

The present invention generally relates to an apparatus, system, and method of controlling image forming apparatus with autonomous navigation system, and non-transitory recording medium.

Description of the Related Art

The recent image forming apparatuses may be provided with an autonomous navigation system, which moves the image forming apparatus to a user who requests for printing. When more than one image forming apparatus with the autonomous navigation system is available, the image forming apparatus that is closest to the user is usually selected.

However, the image forming apparatus that is closet may not be the one capable of immediately performing the print request. For example, the image forming apparatus, such as the image forming apparatus that forms an image with ink, may sometimes run out of ink. In such case, the image forming apparatus is able to only print an image, only for a limited time period.

### SUMMARY

Example embodiments of the present invention include an apparatus, method, and system for controlling a plurality of image forming apparatuses each provided with an autonomous navigation system that enables the image forming apparatus to travel to a destination, each of which: receives a user request for printing image data from an information terminal operated by a user through a network; receives first location information indicating a current location of each one of the plurality of image forming apparatuses, and second location information indicating a current location of the information terminal; receives device information from each one of the plurality of image forming apparatuses, the device information at least including a monochrome printing time that indicates a time period in which the image forming apparatus performs monochrome printing when the image forming apparatus is not capable of performing color printing; selects one of the plurality of image forming apparatuses as an image forming apparatus to perform printing according to the user request, based on the first location information, the second location information, and the device information; and instructs the selected image forming apparatus to travel to the information terminal operated by the user and perform printing according to the user request.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of an image forming system according to an embodiment;

FIG. 2 is a schematic block diagram illustrating a hardware configuration of the image forming system of FIG. 1, according to an embodiment;

FIG. 3 is a schematic block diagram illustrating a hardware configuration of an autonomous navigation system in the image forming apparatus, according to an embodiment;

FIG. 4 is a schematic block diagram illustrating a functional configuration of the image forming system of FIG. 1, according to an embodiment;

FIG. 5 is a data sequence diagram illustrating operation of processing printing, performed by the image forming system of FIG. 1, according to an embodiment;

FIG. 6 is a data sequence diagram illustrating operation of processing printing, performed by the image forming system of FIG. 1, according to an embodiment;

FIG. 7 is a flowchart illustrating operation of determining an image forming apparatus to process printing, performed by the server, according to an embodiment;

FIG. 8 is a flowchart illustrating operation of determining an image forming apparatus to process printing, performed by the server, according to an embodiment; and

FIG. 9 is a flowchart illustrating operation of determining an image forming apparatus to process printing, performed by the server, according to an embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

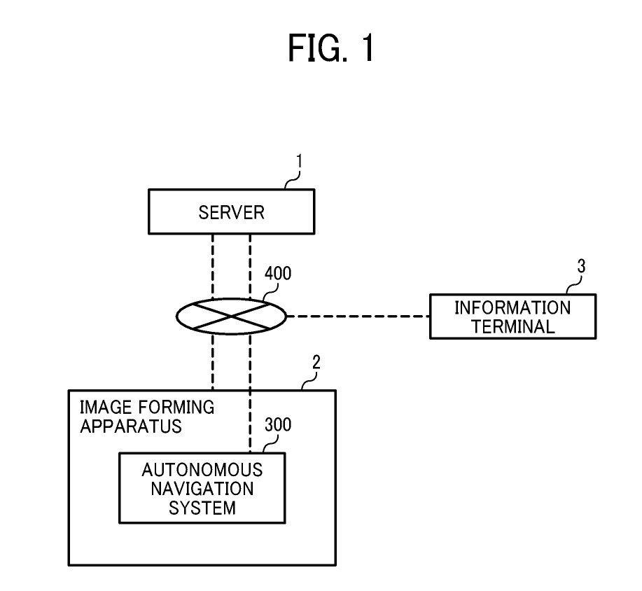

Referring to the drawings, embodiments of the present invention are described. FIG. 1 is a schematic block diagram illustrating an image forming system according to an embodiment.

The image forming system includes a server 1, an image forming apparatus 2 provided with an autonomous navigation system 300, and an information terminal 3 operated by a user, which are connected to a network 400. In example operation, the information terminal 3 transmits a print request with image data to be printed, to the server 1 through the network 400. Based on the print request received from the information terminal 3, the server 1 determines a current location of the information terminal three operated by the user.

The server 1 instructs the image forming apparatus 2, with the autonomous navigation system 300, to move to the current location of the information terminal 3. The server 1 further transmits the image data received with the print request from the information terminal 3, to the image forming apparatus 2. The image forming apparatus 2, which receives the image data from the server 1, forms an image based on the image data. In FIG. 1, only one apparatus is provided for each one of the server 1, the image forming apparatus 2, and the information terminal 3, however, any desired number of such apparatuses may be provided in the image forming system. In the following embodiment, it is assumed that more than one image forming apparatus 2 is provided, which is being controlled by the server 1.

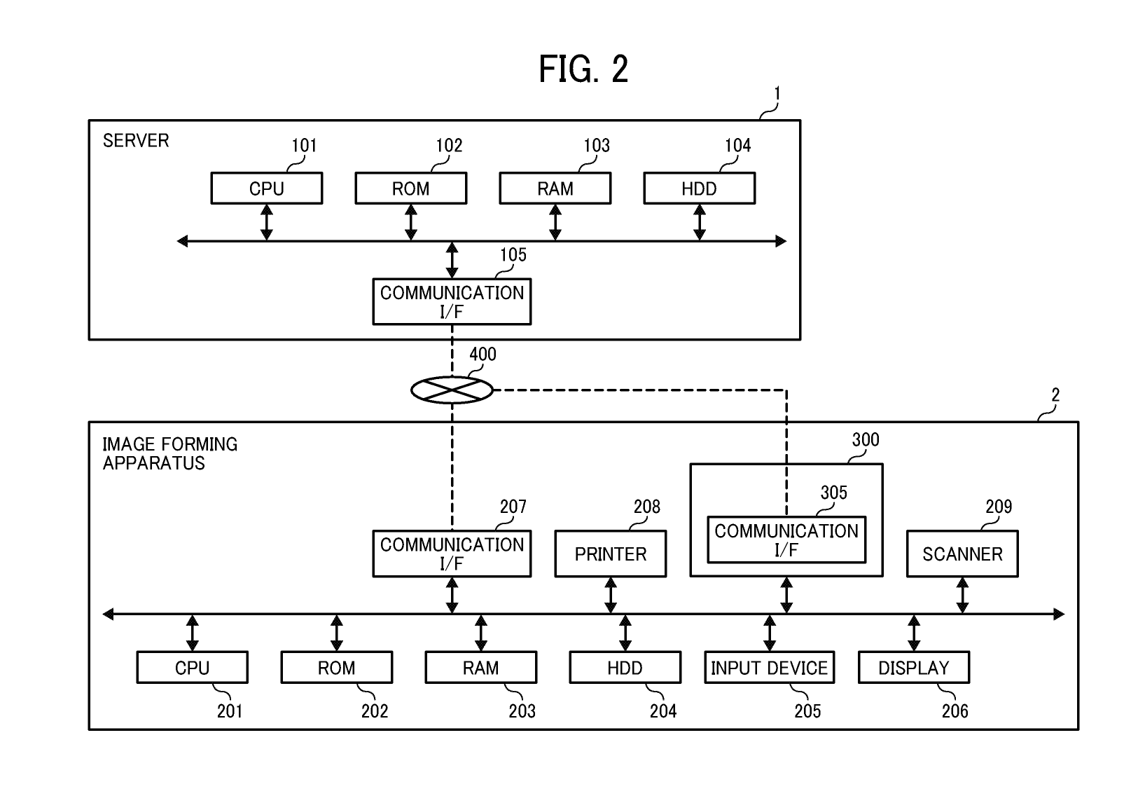

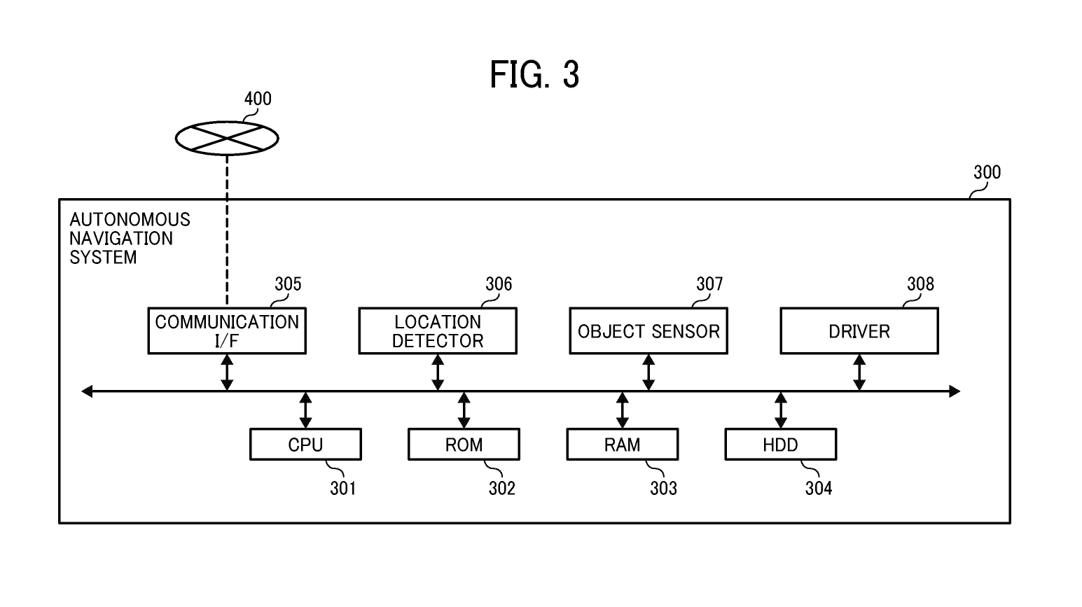

Next, referring to FIG. 2, a hardware configuration of the image forming system of FIG. 1 is described. The image forming apparatus 2 in this embodiment is provided with the autonomous navigation system 300, which will be described in detail referring to FIG. 3.

The server 1 includes a central processing unit (CPU) 101, a read only memory (ROM) 102, a random access memory (RAM) 103, and a hard disk drive (HDD) 104. The CPU 101 controls entire operation of the server 1 according to a control program. The ROM 102 stores various programs, such as the control program, to be executed by the CPU 101, for example, when the server 1 is turned on. The RAM 103 functions as a work area for the CPU 101. The HDD 104 stores various data such that data are kept stored after the power of the server 1 is turned off.

The server 1 further includes a communication interface (I/F) 105, which transmits or receives various information to or from an electronic apparatus such as an external device or a computer, through the network 400. The communication I/F 105 may be implemented by a USB port, LAN port, wireless LAN port, infrared communication I/F, or any other device that enables communication of data with the external device. Depending on a type of the communication I/F 105, the communication I/F 105 does not have to be connected to the network 400.

Next, a hardware configuration of the image forming apparatus 2 is described. The image forming apparatus 2 includes a central processing unit (CPU) 201, a read only memory (ROM) 202, a random access memory (RAM) 203, a hard disk drive (HDD) 204, an input device 205, and a display 206. The CPU 201 controls entire operation of the image forming apparatus 2 according to a control program. The ROM 202 stores various programs, such as the control program, to be executed by the CPU 201, for example, when the image forming apparatus 2 is turned on. The RAM 203 functions as a work area for the CPU 201. The HDD 204 stores various data such that data are kept stored after the power of the image forming apparatus 2 is turned off. The input device 205 may be implemented by, for example, a mouse and various input keys. The display 206 may be implemented by, for example, a liquid crystal display (LCD) or an organic EL.

The image forming apparatus 2 further includes a communication I/F 207, a printer 208, the autonomous navigation system 300, and a scanner 209. These devices, which may be referred to as dedicated devices, operate under control of the CPU 201. The autonomous navigation system 300 includes a communication I/F 305.

The communication I/F 207 of the image forming apparatus 2 allows communication of various data with an electronic device such as an external device or a computer, for example, through the network 400. More specifically, the communication I/F 207 transmits or receives image data to or from the image forming apparatus 2. The communication I/F 207 may be implemented by a USB port, LAN port, wireless LAN port, or any other device that enables communication of data with the external device. Depending on a type of the communication I/F 207, the communication I/F 207 does not have to be connected to the network 400.

The printer 208 of the image forming apparatus 2 forms an image on a recording sheet based on image data. Any desired image forming method may be used, such as electrophotographic printing using a photoconductor, or ink-jet printing.

The scanner 209 of the image forming apparatus 2 scans an original document into image data, using an optical system. Any desired scanner may be used, such as an image scanner or a CT scanner.

The autonomous navigation system 300 moves the image forming apparatus 2 according to a control program. The autonomous navigation system 300 may be incorporated in the image forming apparatus 2. Alternatively, the autonomous navigation system 300 may be attached to the image forming apparatus 2 to be freely removable from the apparatus 2. Alternatively, the autonomous navigation system 300 may be formed as a cart capable of carrying the image forming apparatus 2. As long as the autonomous navigation system 300 is capable of moving the image forming apparatus 2, its appearance or structure is not limited to this disclosure. The autonomous navigation system 300 is provided with a communication function to enable communication of data with the external device.

Referring to FIG. 3, a hardware configuration of the autonomous navigation system 300 is described. The autonomous navigation system 300 includes a central processing unit (CPU) 301, a read only memory (ROM) 302, a random access memory (RAM) 303, and a hard disk drive (HDD) 304. The CPU 301 controls entire operation of the autonomous navigation system 300 according to a control program. The ROM 302 is a read only memory that stores various programs, such as the control program, to be executed by the CPU 301. The RAM 303 functions as a work area for the CPU 301. The HDD 304 stores various data such that data are kept stored after the power of the autonomous navigation system 300 is turned off.

The autonomous navigation system 300 further includes a communication I/F 305, a location detector 306, an object sensor 307, and a driver 308.

The communication I/F 305 of the autonomous navigation system 300 allows communication of various data with an electronic device such as an external device or a computer, through the network 400. More specifically, the communication I/F 305 transmits or receives image data to or from the autonomous navigation system 300. The communication I/F 305 may be implemented by a USB port, LAN port, wireless LAN port, or any other device that enables communication of data with the external device. Depending on a type of the communication I/F 305, the communication I/F 305 does not have to be connected to the network 400.

The location detector 306 of the autonomous navigation system 300 detects a current location of the autonomous navigation system 300. In this embodiment, the location detector 306 includes a sensor, which detects a location detection marker (landmark) provided on such as a ceiling of an office, to obtain an accurate location and position of the image forming apparatus 2. The location detector 306 may detect a landmark provided on the image forming apparatus 2, to obtain a home position to be referred to by the server 1. The location detector 306 further includes an interface circuit that receives a detection signal output from the sensor for location detection. The interface circuit outputs a detection result based on the detection signal to the outside through the communication I/F 305.

When moving by the autonomous navigation system 300, the image forming apparatus 2 constantly detects the landmarks, which are provided at more than two locations in the office such as on the ceiling, using the sensor in the location detector 306. The CPU 301 calculates the current location of the image forming apparatus 2 based on the two or more landmarks that are detected, as a reference, using a triangulation method.

The object sensor 307 detects an object on a traveling route of the image forming apparatus 2, such as an object ahead of the image forming apparatus 2.

The driver 308 includes drive wheels, and drive motors for driving the drive wheels. The drive wheels includes two right wheels and two left wheels, each of which is independently provided with the drive motor. Using the differential drive method, right and left drive wheels can be independently driven. In such case, a number of rotations are changed respectively for the right and left drive wheels to change a travelling direction of the image forming apparatus 2 with relatively a small turning radius. The number of rotations of the drive wheels may be used to estimate a location to be travelled or a travelling direction.

Alternatively, the autonomous navigation system 300 may be provided with a steering wheel, which may be rotated to change a travelling direction. To improve balance, the autonomous navigation system 300 may be further provided with one or more auxiliary wheels. However, a gyroscope or an acceleration sensor may be provided to measure a number of rotations to keep a balance, while omitting the auxiliary wheels. In alternative to the wheels, the autonomous navigation system 300 may include a crawler that drives a caterpillar belt to move the image forming apparatus 2. Alternatively, the autonomous navigation system 300 may drive the image forming apparatus 2, with two or more legs, such as a robot.

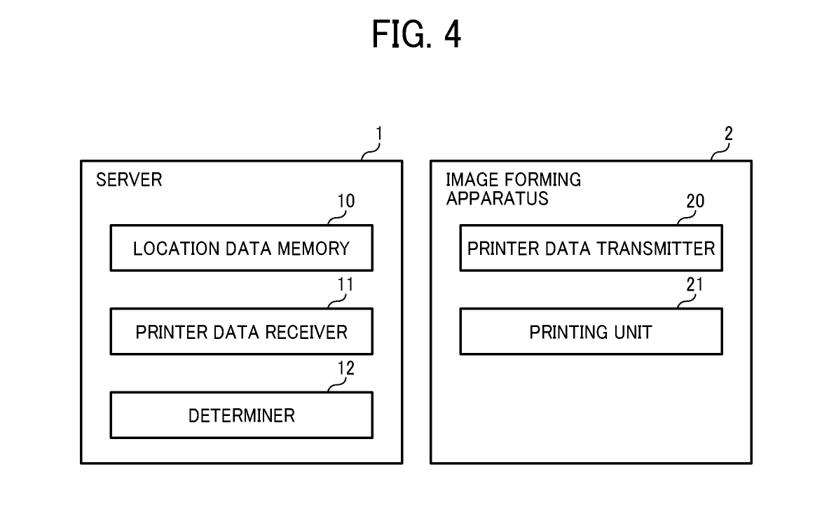

Referring to FIG. 4, a functional configuration of the image forming system is described. The image forming system includes the server 1 and the image forming apparatus 2. The server 1 includes a location data memory 10, a printer data receiver 11, and a determiner 12. The image forming apparatus 2 includes a printer data transmitter 20 and a printing unit 21.

The location data memory 10 of the server 1 stores location data for each apparatus being managed. In this embodiment, the apparatuses being managed include a plurality of image forming apparatuses 2 each provided with the autonomous navigation system 300, and a plurality of information terminals 3 operated by the user. The location data of each image forming apparatus 2 is a home position, which is an initial position, of the image forming apparatus 2 that is previously stored. Since the image forming apparatus 2 is provided with the autonomous navigation system 300, when travelling, the autonomous navigation system 300 periodically transmits the current location of the image forming apparatus 2 to the server 1 through the network 400. The server 1 further obtains the current location of the information terminal 3, when a print request or any other action is received from the user at the information terminal 3, for example, in association with URL information. In case the image forming system is constructed in the office environment, the initial position of the image forming apparatus 2 may be stored in a memory accessible by the server 1 as map information.

For example, the location data memory 10 of the server 1 may be implemented by the HDD 104, which may be controlled by the CPU 101 based on various information received from the communication I/F 105.

The printer data receiver 11 of the server 1 receives printer data from the image forming apparatus 2. The printer data in this disclosure includes various information relating to printing to be performed by the image forming apparatus 2 or relating to the image forming apparatus 2. Examples of the printer data include, but not limited to, operating state information indicating a current operating state of the image forming apparatus 2, and device-specific information (“device information”) such as a type of printing available to the image forming apparatus 2 (color printing or monochrome printing), and an estimated time period in which monochrome printing can be performed in case color printing is not available (“estimated time for monochrome printing”). The current operating state may indicate whether the image forming apparatus 2 is currently performing a print job or waiting for a print job. The other example of the printer data is an estimated time period required to complete maintenance on the image forming apparatus 2 (“estimated maintenance time”), which may be an example of the device information.

The server 1 may request the image forming apparatus 2 to transmit specific types of printer data, for example, according to a control program stored in the ROM 102. For example, the printer data receiver 11 of the server 1 may be implemented by the communication I/F 105, which operates under control of the CPU 101 based on the control program.

The determiner 12 of the server 1 selects one of the image forming apparatuses 2, as the image forming apparatus 2 to process the print request from the user, based on the current locations of the information terminal 3 and the image forming apparatus 2, and the printer data received from the image forming apparatuses 2.

For example, it is assumed that the user requests to print with color ink. In case when all of the image forming apparatuses 2 are filled with color ink sufficient to perform color printing as requested by the user, the server 1 selects one of the image forming apparatuses 2, which is closest in distance to the user based on the current locations of the image forming apparatuses 2 and the information terminal 3.

However, for most cases, there is at least one image forming apparatus 2 that almost or completely runs out of color ink for at least one color. Such image forming apparatus 2, which is not capable of performing color printing, can only perform monochrome printing, unless it is filled with color ink again for that color. Examples of the case in which the image forming apparatus 2 is not capable of performing color printing include, but not limited to, the following.

In one example, when the image forming apparatus 2 runs out of color ink for at least one color, the image forming apparatus 2 switches to perform monochrome printing. In another example, when the image forming apparatus 2 almost runs out of color ink for at least one color, the image forming apparatus 2 switches to perform monochrome printing. In this disclosure, the image forming apparatus 2 that almost runs out of color ink is a state, in which an amount of color ink for at least one color component is less than a threshold set by, for example, a manufacturer. The threshold may be set, for example, as a percentage to a maximum, such as 1%, 5%, or 10%.

In another example, the server 1 may calculate an amount of color ink to be used for printing a color image based on the image data to be printed, and compares the calculated amount of color ink with a remaining amount of color ink to determine whether the image forming apparatus is capable of printing the color image with the remaining amount of color ink. For example, the server 1 calculates an estimated amount of color ink to be used for printing, based on a number of dots in the image data to be printed. When the server 1 determines that the calculated amount of color ink is greater than the remaining amount of color ink for the image forming apparatus 2, the server 1 determines that the image forming apparatus 2 is not capable of performing color printing.

The image forming apparatus 2 not capable of performing color printing can only perform monochrome printing, during a limited time period, which is previously set, for example, by a manufacturer. For example, the image forming apparatus 2 is set, such that, when a determination is made that the image forming apparatus 2 is not capable of performing color printing, the image forming apparatus 2 can perform monochrome printing for the limited time period. For example, the value of the limited time period may be set to several days, such as 5 days or 10 days, according to the specification of the image forming apparatus 2. If the limited time period elapses, the image forming apparatus 2 determines not to perform monochrome printing, even when the image forming apparatus 2 has a sufficient amount of black ink to perform monochrome printing.

That is, when the request for printing is received during such time period, even if the image forming apparatus 2 closest to the user is selected, that selected image forming apparatus 2 can only print a monochrome image. Further, when the request for printing is received during such time period, even if the image forming apparatus 2 can print a monochrome image, the image forming apparatus 2 may not be able to complete printing if the limited time period that is set is less than a time required for printing. The limited time period that is previously set is referred to as the estimated time for monochrome printing. As described above, the estimated time for monochrome printing may be set to a time period that is previously set by, for example, a manufacturer of the image forming apparatus 2.

In view of the above, in one embodiment, when none of the image forming apparatuses 2 is filled with a sufficient amount of color ink for at least one color (the example case that color printing cannot be performed), the server 1 may compare an estimated time required to complete color printing based on the user print request (“estimated time for printing), with an estimated time in which monochrome printing is to be performed (“estimated time for monochrome printing”). Based on the comparison, the server 1 selects the image forming apparatus 2 to perform printing according to the user print request. More specifically, the server 2 subtracts, from the estimated time for monochrome printing, the estimated time for printing, to obtain a time difference. The image forming apparatus 2 having the largest time difference is selected, as the image forming apparatus 2 to perform printing according to the user print request. In this way, the image forming apparatus 2 that can perform monochrome printing to complete printing as requested by the user is selected.

In some cases, the user may want to have a print output as soon as possible. That is, the current location of the information terminal 3, and the current location of the image forming apparatus 2 need to be taken into account. The image forming apparatus 2 that is closest to the user should be selected with high priority.

In view of the above, in one embodiment, the server 1 generates a travelling route of the image forming apparatus 2, from the current location of the image forming apparatus 2 to the current location of the information terminal 3. Based on the travelling route, the server 1 calculates a travelling time required for the image forming apparatus 2 to arrive at the information terminal 3. The server 1 then compares a sum of the travelling time and the estimated time for printing, with the estimated time for monochrome printing. Based on the comparison, the server 1 selects the image forming apparatus 2 to perform printing according to the user print request. More specifically, the server 1 subtracts, from the estimated time for monochrome printing, the sum of the travelling time and the estimated time for printing, to obtain a time difference. The image forming apparatus 2 having the largest time difference is selected, as the image forming apparatus 2 to perform printing according to the user print request.

Since the image forming apparatus 2 having the largest time difference is closest in distance to the user, the user at the information terminal 3 is able to have a print output with less waiting time. In this embodiment, the image forming apparatus 2 may perform color printing, while travelling to the travelling destination. Alternatively, the image forming apparatus 2 may perform color printing, after the image forming apparatus 2 arrives at the travelling destination. The latter case may be preferable, if the user does not want the other to see the print output, for example, in case of printing confidential information.

In other embodiment, the image forming apparatus 2 may periodically perform automatic calibration to check if the image forming apparatus 2 normally operates, for example, when the power is turned on. In view of this, a time required for completing maintenance such as calibration (“estimated maintenance time”) may be taken into consideration.

For example, the server 1 may compare a sum of the estimated maintenance time and the estimated time for printing, with the estimated time for monochrome printing. Based on the comparison, the server 1 selects the image forming apparatus 2 to perform printing according to the user print request. More specifically, the server 1 subtracts, from the estimated time for monochrome printing, the sum of the estimated maintenance time and the estimated time for printing, to obtain a time difference. The image forming apparatus 2 having the largest time difference is selected, as the image forming apparatus 2 to perform printing according to the user print request.

Since the image forming apparatus 2 having the largest time difference requires less maintenance time, the user at the information terminal 3 is able to have a print output with less waiting time.

The determiner 12 of the server 1, which selects the image forming apparatus 2 as described above, may be implemented by the CPU 101 according to the control program that may be read from the HDD 104 onto the RAM 103.

The printer data transmitter 20 of the image forming apparatus 2 transmits the printer data to the server 1. The printer data may be any information relating to printing to be performed by the image forming apparatus 2, or information regarding the image forming apparatus 2. In addition to the printer data, the image forming apparatus 2 may transmit the current location of the image forming apparatus 2, which is output from the autonomous navigation system 300, to the server 1. The image forming apparatus 2 may transmit information at any desired time, for example, in response to a request from the server 1 or according to the control program executed by the image forming apparatus 2. In one example, in response to a request for information regarding the estimated time from the server 1, the image forming apparatus 2 obtains from the HDD 204 such information that is previously stored, for transmission to the server 1. Examples of the estimated time include, as described above, the estimated time for printing, estimated time for monochrome printing, and estimated maintenance time. In another example, in response to the request from the server 1 or periodically, the image forming apparatus 2 obtains the current location of the image forming apparatus 2 from the autonomous navigation system 300 for transmission to the server 1.

In case of the estimated time for printing, the image forming apparatus 2 may determine contents of the print request, such as a number of pages, a type of editing to be performed, and complication of an image to be formed such as a number of graphical images, etc. Based on this information, the image forming apparatus 2 may refer to a table storing an estimated printing time in association with features describing the contents of the print request, to obtain the estimated time for printing. The estimated time for printing, may be obtained by the server 1 in a substantially similar manner.

In case of the estimated time for monochrome printing, the image forming apparatus 2 may refer to a table storing an estimated time period when the image forming apparatus 2 can perform monochrome printing, to obtain the estimated time for monochrome printing. This estimated time for monochrome printing may be set, for example, by a manufacturer based on empirical data.

In case of the estimated maintenance time, the image forming apparatus 2 may refer to a table storing an estimated time period required to complete maintenance, to obtain the estimated maintenance time. This estimated maintenance time may be set, for example, by a manufacturer based on empirical data.

The printer data transmitter 20 of the image forming apparatus 2 may be implemented by, for example, the communication I/F 207, which operates under control of the CPU 201 according to the control program stored in any desired memory of the image forming apparatus 2.

The printing unit 21 of the image forming apparatus 2 controls the printer 208 to form an image based on the image data received from the server 2, to perform printing according to the user print request. Further, the image forming apparatus 2, which is determined by the server 1 to perform printing, travels to the information terminal 3 operated by the user. The image forming apparatus 2 may perform printing, while travelling to the travelling destination, or after arriving at the travelling destination.

The printing unit 21 of the image forming apparatus 2 may be implemented by the printer 208, under control of the CPU 201 according to the control program stored in any desired memory of the image forming apparatus 2.

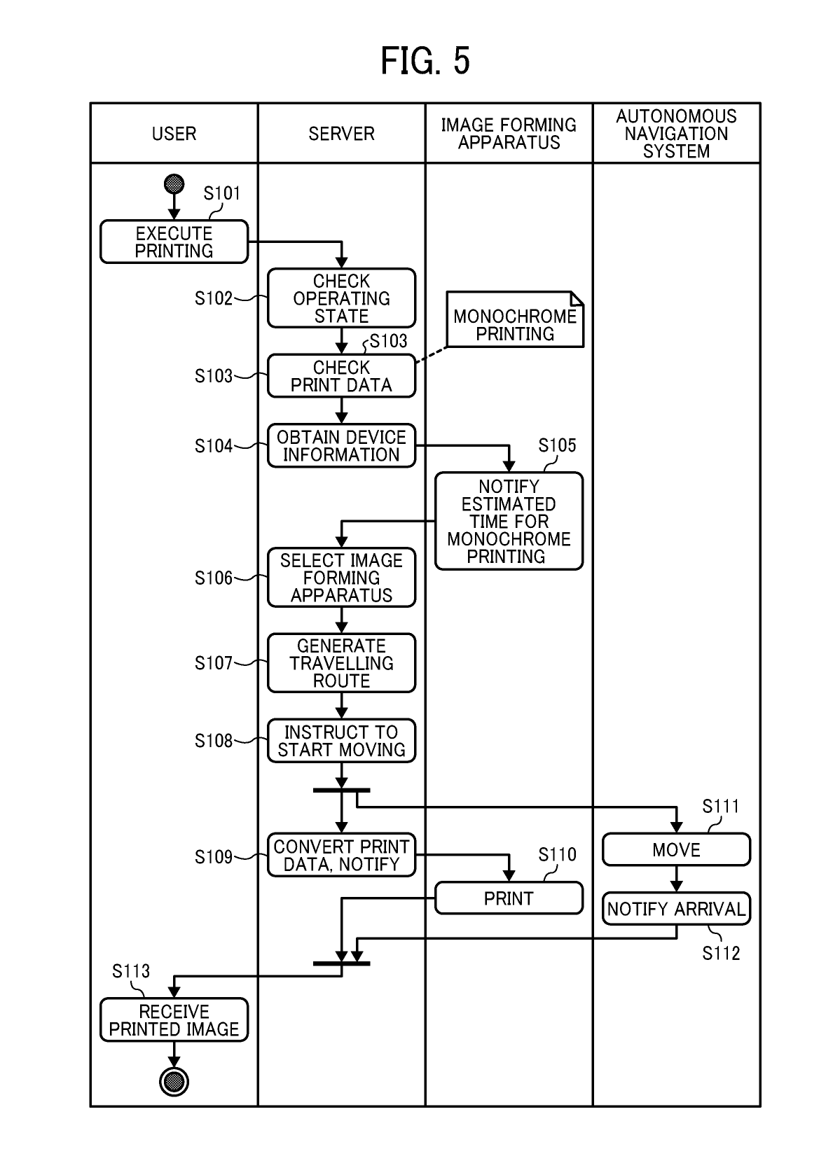

Referring now to FIG. 5, operation of controlling printing, performed by the image forming system of FIG. 1, is described according to an embodiment. In this embodiment of FIG. 5, the image forming apparatus 2 performs printing while travelling to the information terminal 3 operated by the user.

At S101, the server 1 receives a print request for printing image data from the user at the information terminal 3. For example, the information terminal 3, installed with printer application, receives a user instruction that selects image data to be printed and print configurations, and transmits the print request to the server 1 through the network 400. In this example, it is assumed that the user instruction instructs to perform color printing.

At S102, the server 1 requests each of the image forming apparatuses 2 being managed by the server 1, for operating state information indicating the current operating state of the image forming apparatus 2. The server 1 is provided with information regarding each image forming apparatus 2 being managed, such as a device ID and destination information such as an IP address of the image forming apparatus 2.

In alternative to requesting each image forming apparatus 2 being managed, the server 1 may analyze a type of processing to be performed on the image data to be printed, to determine one or more image forming apparatuses capable of performing printing as requested by the user.

Based on the current operating state of each image forming apparatus 2, the server 1 selects one or more image forming apparatuses 2 capable of performing printing (waiting state). At S103, the server 1 further requests those image forming apparatuses 2 in waiting state, for information regarding availability of color ink. Based on the responses from the image forming apparatuses 2, it is assumed that all of the image forming apparatuses 2 almost run out of color ink for at least one color component. In such case, the image forming apparatus 2 performs monochrome printing, for a limited time period. Based on this result, at S103, the server 1 obtains an estimated time for printing, for example, based on the type of processing to be performed on the image data.

At S104, the server 1 further requests the image forming apparatuses 2 that is in a waiting state and almost runs out of color ink, for device-specific information (“device information”). More specifically, in this example, the server 1 requests each image forming apparatus 2 for an estimated time for monochrome printing. In response to the request, at S105, each image forming apparatus 2 sends the estimated time for monochrome printing.

At S106, the server 1 selects one image forming apparatus 2 to perform printing, based on a difference time between the estimated time for printing and the estimated time for monochrome printing.

At S107, the server 1 generates a travelling route from the current location of the selected image forming apparatus 2 to the information terminal 3 operated by the user. The current locations of the image forming apparatus 2 and the information terminal 3 are respectively received from the image forming apparatus 2 and the information terminal 3.

At S108, the server 1 transmits the generated travelling route to the selected image forming apparatus 2, to instruct the selected image forming apparatus 2 to travel to the information terminal 3. In response to the instruction, at S111, the autonomous navigation system 300 on the image forming apparatus 2 starts travelling based on the received travelling route.

At S109, the server 1 converts the image data as needed to be in compliance with the selected image forming apparatus 2, and sends an instruction for printing the image data to the selected image forming apparatus 2. In this example, the instruction for travelling and the instruction for printing are transmitted substantially at the same time.

At S110, the image forming apparatus 2, which receives the instruction for printing, starts printing, while travelling with the autonomous navigation system 300.

When the image forming apparatus 2 arrives at the destination where the information terminal 300 resides, the autonomous navigation system 300 notifies the server 1 of its arrival at the destination.

At S113, the image forming apparatus 2 completes processing to output a printed image to the user. At this time, the image forming apparatus 2 may notify the server 1 of completion of the print job. In response to the notification indicating arrival and completion of print job, the server 1 may send a notification to the information terminal 3 indicating completion of the user print request.

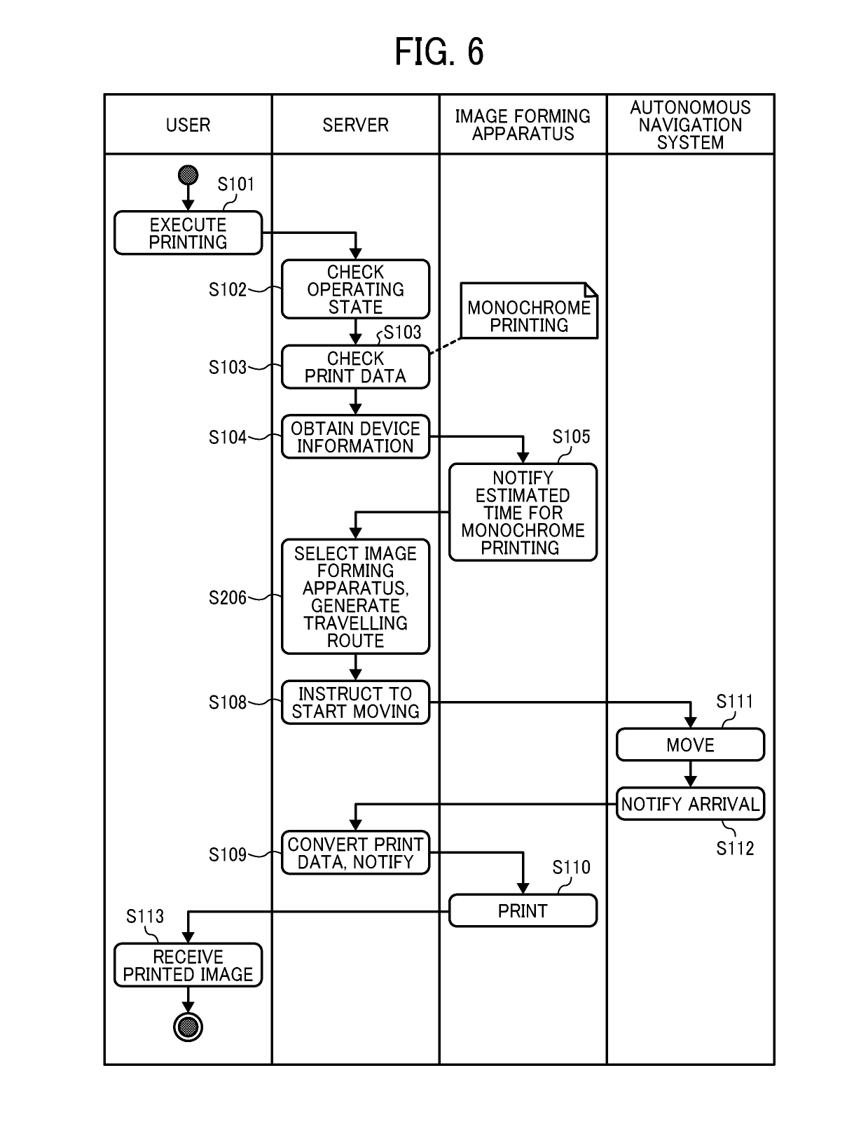

Referring now to FIG. 6, operation of controlling printing, performed by the image forming system of FIG. 1, is described according to an embodiment. In this embodiment of FIG. 6, the image forming apparatus 2 performs printing after arrival to the destination where the information terminal 3 operated by the user resides.

The operation of FIG. 6 is performed in a substantially similar manner as described above referring to FIG. 5, except for replacement of S106 and S107 with S206, and an order of performing S108 to S110. More specifically, the server 1 generates the travelling route of the selected image forming apparatus 2, right after the image forming apparatus 2 is selected. At S108, the server 1 transmits an instruction for performing a print job, with the travelling route, to the autonomous navigation system 300 on the selected image forming apparatus 2.

When the selected image forming apparatus 2 arrives at the destination, where the information terminal 300 resides, at S112, the autonomous navigation system 300 notifies the server 1 of the arrival.

Based on this notification, at S109, the server 1 sends an instruction for printing the image data to the selected image forming apparatus 2, to cause the selected image forming apparatus 2 to print the image data.

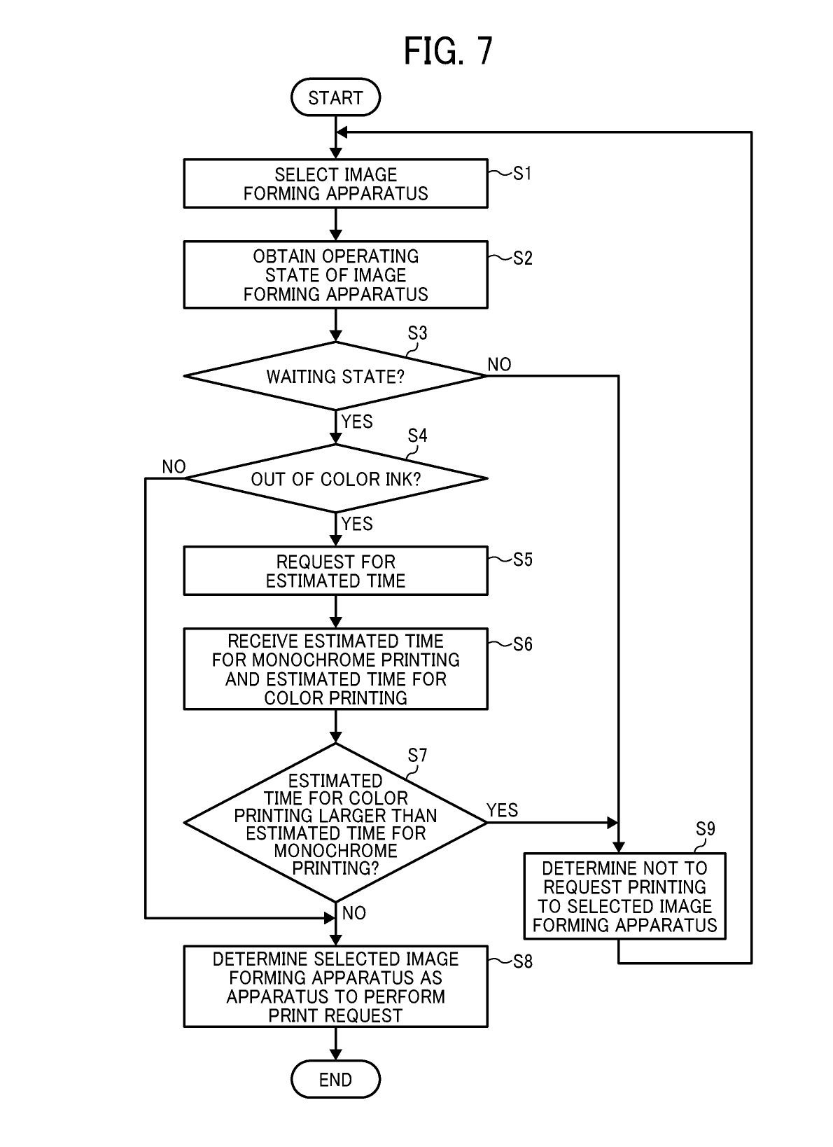

The operation of determining the image forming apparatus 2 to perform printing may be performed in various ways, based on various criterion, for example, as described below referring to FIGS. 7 to 9.

FIG. 7 is a flowchart illustrating operation of determining the image forming apparatus to process printing, performed by the CPU 101 of the server 1, according to an embodiment. The operation of FIG. 7 is performed in response to a print request received from the information terminal 3, at S101 of FIG. 5 or 6. Further, in this embodiment, it is assumed that the print request instructs to print a color image.

At S1, the server 1 selects one of the image forming apparatuses 2 being managed by the server 1, as a candidate of the image forming apparatus 2 to process printing.

At S2, the server 1 obtains a current operating state of the image forming apparatus 2. The current operating state indicates whether the image forming apparatus 2 is currently executing a print job, or waiting for a job. At S3, the server 1 determines whether the current operating state indicates that the image forming apparatus 2 is waiting for a job. When it is determined that the image forming apparatus 2 is in the waiting state (“YES” at S3), the operation proceeds to S4. At S4, the server 1 obtains information regarding availability of a color ink, from the image forming apparatus 2, as device information that is one example of printer data transmitted from the image forming apparatus 2.

When it is determined that the image forming apparatus 2 is almost or completely out of color ink (even in one color), at S5, the server 1 requests the image forming apparatus 2 to further send an estimated time for monochrome printing, and an estimated time for printing according to the user request. As described above referring to FIGS. 5 and 6, the estimated time for printing may be obtained at the server 1. At S6, in response to the request, the image forming apparatus 2 obtains such information from the HDD 204, and sends the estimated time for monochrome printing and the estimated time for printing to the server 1.

At S7, the server 1 determines whether the estimated time for printing is greater than the estimated time for monochrome printing. When it is determined that the estimated time for printing is greater than the estimated time for monochrome printing (“YES” at S7), the operation proceeds to S9 to determine not to select the image forming apparatus 2 under consideration, as the image forming apparatus 2 to perform printing according to the user print request. The operation then proceeds to select another image forming apparatus 2 to repeat S1 to S7. When it is determined that the estimated time for printing is equal to or less than the estimated time for monochrome printing (“NO” at S7), the server 1 selects the image forming apparatus 2 as a candidate to perform printing, and the operation proceeds to S8.

At S8, when there is at least one image forming apparatus 2 having color ink (“NO” at S4), the server 1 selects one of such image forming apparatuses 2 that is closest to the user. At S8, when all candidates of the image forming apparatuses 2 are only capable of performing monochrome printing (“YES” at S4, and “NO” at S7), the server 1 selects one of such image forming apparatuses 2 having the largest time difference, between the estimated time for monochrome printing and the estimated time for printing. If there is more than one such image forming apparatus 2, the image forming apparatus 2 closest to the user is selected.

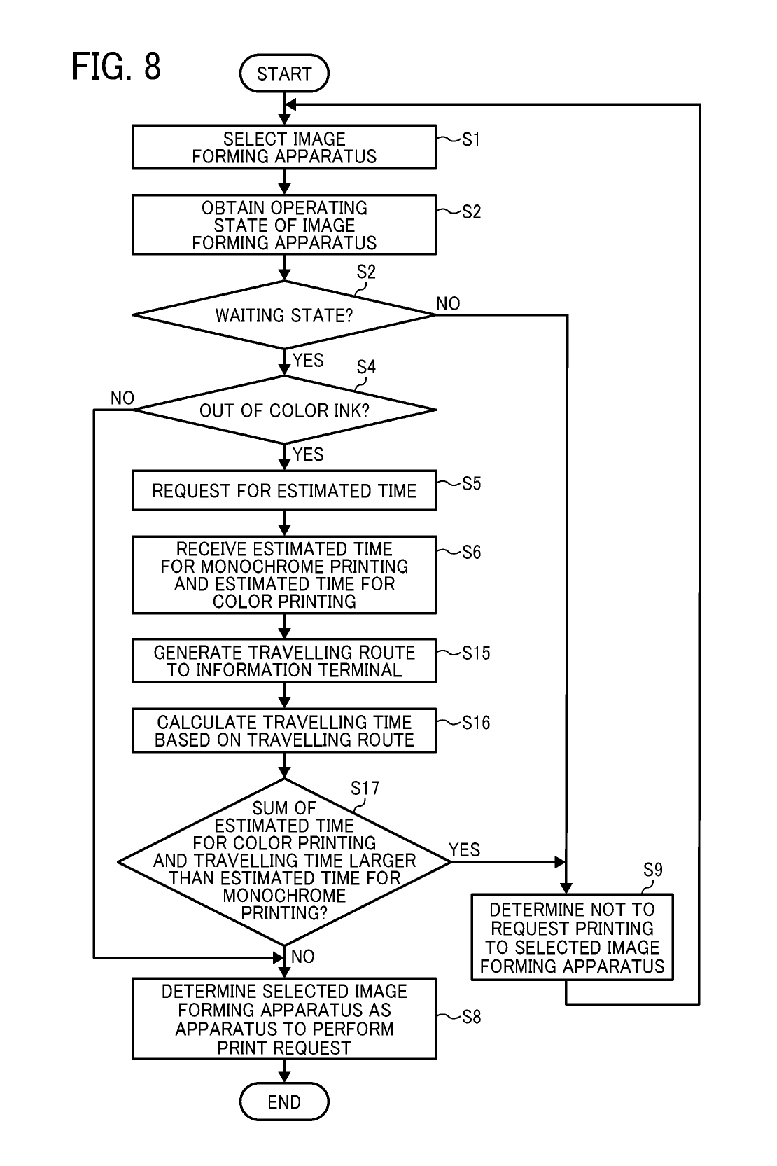

FIG. 8 is a flowchart illustrating operation of determining the image forming apparatus to process printing, performed by the CPU 101 of the server 1, according to an embodiment.

S1 to S6 are performed in a substantially similar manner as described above referring to S1 to S6 of FIG. 7.

At S15, the server 1 generates a travelling route, from the current location of the information terminal 3 and the current location of the image forming apparatus 2 that are respectively stored at the server 1. The current locations of the image forming apparatus 2 and the information terminal 3 may be received by the server 1 at any desired time, either constantly or upon request from the server 1.

At S16, the server 1 calculates an estimated time required for the image forming apparatus 2 to travel from the current location to the destination location where the information terminal 3 resides. The calculated estimated time is referred to as the estimated travelling time.

At S17, the server 1 determines whether a sum of the estimated time for printing and the estimated travelling time is greater than the estimated time for monochrome printing. When it is determined that the sum of the estimated time for printing and the estimated travelling time is greater than the estimated time for monochrome printing (“YES” at S17), the operation proceeds to S9 to determine not to select the image forming apparatus 2 under consideration, as the image forming apparatus 2 to perform printing according to the user print request. The operation then proceeds to select another image forming apparatus 2 to repeat S1 to S17. When it is determined that the sum of the estimated time for printing and the estimated travelling time is equal to or less than the estimated time for monochrome printing (“NO” at S17), the server 1 selects the image forming apparatus 2 as a candidate to perform printing, and the operation proceeds to S8.

At S8, when there is at least one image forming apparatus 2 having color ink (“NO” at S4), the server 1 selects one of such image forming apparatuses 2 that is closest to the user. At S8, when all candidates of the image forming apparatuses 2 are only capable of performing monochrome printing (“YES” at S4, and “NO” at S17), the server 1 selects one of such image forming apparatuses 2 having the largest time difference, between the estimated time for monochrome printing, and the sum of the estimated time for printing and the estimated travelling time. If there is more than one such image forming apparatus 2, the image forming apparatus 2 closest to the user is selected.

The image forming apparatus 2 may perform printing, while travelling to the travelling destination, or after arriving at the travelling destination.

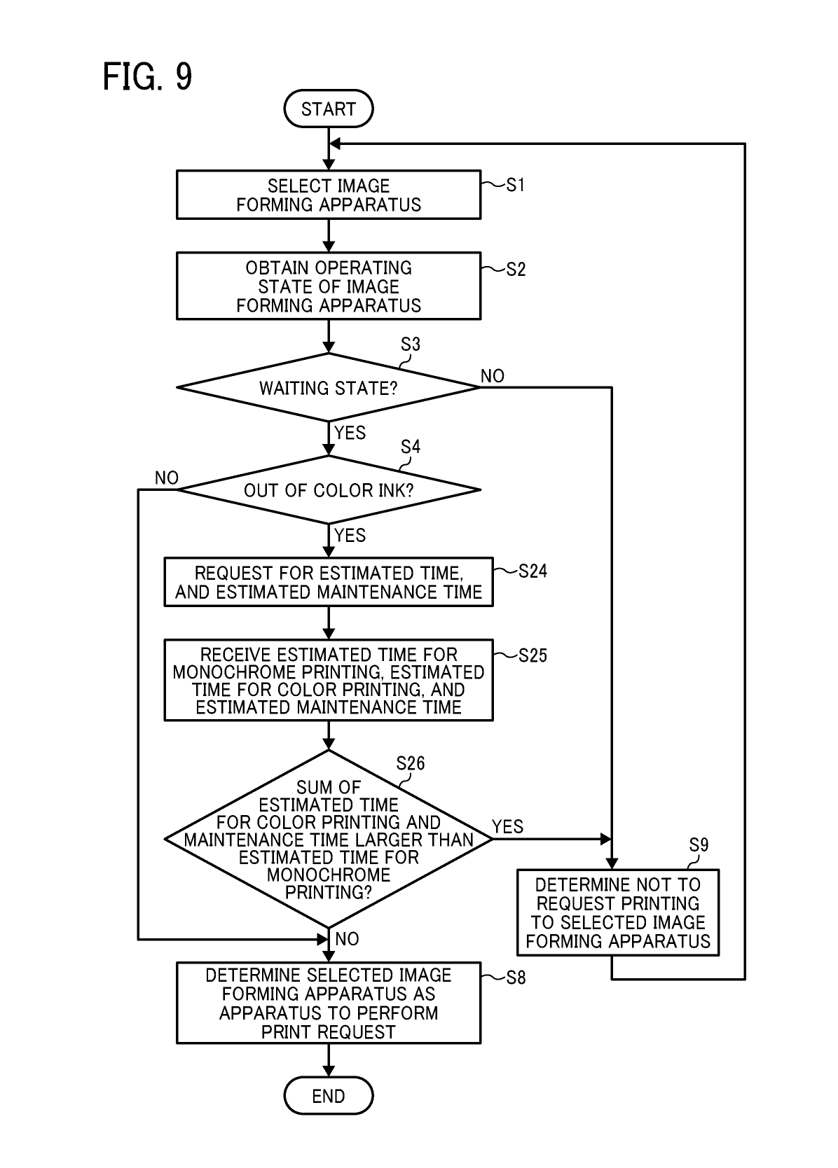

FIG. 9 is a flowchart illustrating operation of determining the image forming apparatus to process printing, performed by the CPU 101 of the server 1, according to an embodiment.

S1 to S4 are performed in a substantially similar manner as described above referring to S1 to S4 of FIG. 7.

When it is determined that the image forming apparatus 2 is almost or completely out of color ink (even in one color), at S24, the server 1 requests the image forming apparatus 2 to further send an estimated time for monochrome printing, an estimated time for printing according to the user request, and an estimated maintenance time. At S25, in response to the request, the image forming apparatus 2 obtains such information from the HDD 204, and sends the estimated time for monochrome printing, the estimated time for printing, and the estimated maintenance time to the server 1.

At S26, the server 1 determines whether the sum of the estimated time for printing and the estimated maintenance time, is greater than the estimated time for monochrome printing. When it is determined that the sum of the estimated time for printing and the estimated maintenance time is greater than the estimated time for monochrome printing (“YES” at S26), the operation proceeds to S9 to determine not to select the image forming apparatus 2 under consideration, as the image forming apparatus 2 to perform printing according to the user print request. The operation then proceeds to select another image forming apparatus 2 to repeat S1 to S26. When it is determined that the sum of the estimated time for printing and the estimated maintenance time is equal to or less than the estimated time for monochrome printing (“NO” at S26), the server 1 selects the image forming apparatus 2 as a candidate to perform printing, and the operation proceeds to S8.

At S8, when there is at least one image forming apparatus 2 having color ink (“NO” at S4), the server 1 selects one of such image forming apparatuses 2 that is closest to the user. At S8, when all candidates of the image forming apparatuses 2 are only capable of performing monochrome printing (“YES” at S4, and “NO” at S26), the server 1 selects one of such image forming apparatuses 2 having the largest time difference, between the estimated time for monochrome printing, and the sum of the estimated time for printing and the estimated maintenance time. If there is more than one such image forming apparatus 2, the image forming apparatus 2 closest to the user is selected.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming system comprising:
a plurality of image forming apparatuses each provided with an autonomous navigation system that enables the image forming apparatus to travel to a destination; and
a server including:
a receiver to receive a user request for printing image data from an information terminal operated by a user through a network; and
circuitry to:
receive first location information indicating a current location of each one of the plurality of image forming apparatuses, and second location information indicating a current location of the information terminal;
receive device information from each one of the plurality of image forming apparatuses, the device information at least including a monochrome printing time that indicates a time period in which the image forming apparatus performs monochrome printing when the image forming apparatus is not capable of performing color printing;
select one of the plurality of image forming apparatuses as an image forming apparatus to perform printing according to the user request, based on the first location information, the second location information, and the device information; and
instruct the selected image forming apparatus to travel to the information terminal operated by the user and perform printing according to the user request.

2. The image forming system of claim 1, wherein the circuitry is further configured to:
obtain a printing time that indicates an estimated time period for printing according to the user request; and
compare, for each one of the image forming apparatuses, between the printing time and the monochrome printing time to generate a comparison result,
wherein the selected image forming apparatus is selected based on the comparison result.

3. The image forming system of claim 1, wherein the circuitry is further configured to:
obtain printing time information that indicates an estimated time period for printing according to the user request;
calculate, for each one of the plurality of image forming apparatuses, a travelling time period required for the image forming apparatus to travel from the current location of the image forming apparatus to the current location of the information terminal, to obtain the travelling time period; and
compare, for each one of the image forming apparatuses, between a sum of the printing time and the travelling time period, and the monochrome printing time to generate a comparison result,
wherein the selected image forming apparatus is selected based on the comparison result.

4. The image forming system of claim 1, wherein the circuitry is further configured to:
obtain printing time information that indicates an estimated time period for printing according to the user request;
calculate, for each one of the plurality of image forming apparatuses, a maintenance time period required for the image forming apparatus to complete maintenance on the image forming apparatus; and
compare, for each one of the image forming apparatuses, between a sum of the printing time and the maintenance time period, and the monochrome printing time to generate a comparison result,
wherein the selected image forming apparatus is selected based on the comparison result.

5. The image forming system of claim 1, wherein the selected image forming apparatus travels to the information terminal operated by the user, while performing printing according to the user request.

6. The image forming system of claim 1, wherein the selected image forming apparatus travels to the information terminal operated by the user, and performs printing according to the user request after arrival at the information terminal.

7. The image forming system of claim 1, wherein the circuitry is further configured to:
determine whether each one of the image forming apparatuses is currently performing other job; and
excludes one or more of the image forming apparatuses currently performing other job, from a candidate of the selected image forming apparatus to perform printing according to the user request.

8. A server for controlling a plurality of image forming apparatuses each provided with an autonomous navigation system that enables the image forming apparatus to travel to a destination, the server comprising:
a receiver to receive a user request for printing image data from an information terminal operated by a user through a network; and
circuitry to:
receive first location information indicating a current location of each one of the plurality of image forming apparatuses, and second location information indicating a current location of the information terminal;
receive device information from each one of the plurality of image forming apparatuses, the device information at least including a monochrome printing time that indicates a time period in which the image forming apparatus performs monochrome printing when the image forming apparatus is not capable of performing color printing;
select one of the plurality of image forming apparatuses as an image forming apparatus to perform printing according to the user request, based on the first location information, the second location information, and the device information; and
instruct the selected image forming apparatus to travel to the information terminal operated by the user and perform printing according to the user request.

9. The server of claim 8, wherein the circuitry is further configured to:
obtain a printing time that indicates an estimated time period for printing according to the user request; and
compare, for each one of the image forming apparatuses, between the printing time and the monochrome printing time to generate a comparison result,
wherein the selected image forming apparatus is selected based on the comparison result.

10. The server of claim 8, wherein the circuitry is further configured to:
obtain printing time information that indicates an estimated time period for printing according to the user request;
calculate, for each one of the plurality of image forming apparatuses, a travelling time period required for the image forming apparatus to travel from the current location of the image forming apparatus to the current location of the information terminal, to obtain the travelling time period; and
compare, for each one of the image forming apparatuses, between a sum of the printing time and the travelling time period, and the monochrome printing time to generate a comparison result,
wherein the selected image forming apparatus is selected based on the comparison result.

11. The server of claim 8, wherein the circuitry is further configured to:
obtain printing time information that indicates an estimated time period for printing according to the user request;
calculate, for each one of the plurality of image forming apparatuses, a maintenance time period required for the image forming apparatus to complete maintenance on the image forming apparatus; and
compare, for each one of the image forming apparatuses, between a sum of the printing time and the maintenance time period, and the monochrome printing time to generate a comparison result,
wherein the selected image forming apparatus is selected based on the comparison result.

12. A method for controlling a plurality of image forming apparatuses each provided with an autonomous navigation system that enables the image forming apparatus to travel to a destination, the method comprising:
receiving a user request for printing image data from an information terminal operated by a user through a network;
receiving first location information indicating a current location of each one of the plurality of image forming apparatuses, and second location information indicating a current location of the information terminal;
receiving device information from each one of the plurality of image forming apparatuses, the device information at least including a monochrome printing time that indicates a time period in which the image forming apparatus performs monochrome printing when the image forming apparatus is not capable of performing color printing;
selecting one of the plurality of image forming apparatuses as an image forming apparatus to perform printing according to the user request, based on the first location information, the second location information, and the device information; and
instructing the selected image forming apparatus to travel to the information terminal operated by the user and perform printing according to the user request.

13. The method of claim 12, further comprising:
obtaining a printing time that indicates an estimated time period for printing according to the user request; and
comparing, for each one of the image forming apparatuses, between the printing time and the monochrome printing time to generate a comparison result,
wherein the selecting selects the image forming apparatus based on the comparison result.

14. The method of claim 12, further comprising:
obtaining printing time information that indicates an estimated time period for printing according to the user request;
calculating, for each one of the plurality of image forming apparatuses, a travelling time period required for the image forming apparatus to travel from the current location of the image forming apparatus to the current location of the information terminal, to obtain the travelling time period; and
comparing, for each one of the image forming apparatuses, between a sum of the printing time and the travelling time period, and the monochrome printing time to generate a comparison result,
wherein the selecting selects the image forming apparatus based on the comparison result.

15. The method of claim 12, further comprising:
obtaining printing time information that indicates an estimated time period for printing according to the user request;
calculating, for each one of the plurality of image forming apparatuses, a maintenance time period required for the image forming apparatus to complete maintenance on the image forming apparatus; and
comparing, for each one of the image forming apparatuses, between a sum of the printing time and the maintenance time period, and the monochrome printing time to generate a comparison result,
wherein the selecting selects the image forming apparatus based on the comparison result.
